(19) United States
(12) Patent Application Publication
(10) Pub. No.: US 2020/0237599 A1
(43) Pub. Date: Jul. 30, 2020

(54) AUTOMATED PHYSICAL THERAPY SYSTEM FOR PROVIDING A RANGE OF MOTION EXERCISES FOR A USER

(71) Applicant: Mark Erb, Menomonie, WI (US)

(72) Inventor: Mark Erb, Menomonie, WI (US)

(21) Appl. No.: 16/847,464

(22) Filed: Apr. 13, 2020

Related U.S. Application Data
(63) Continuation-in-part of application No. 16/734,809, filed on Jan. 6, 2020.
Application No. 16/734,809 is a continuation-in-part of application No. 15/217,037, filed on Jul. 22, 2016, now Pat. No. 10,561,562.
Application No. 15/217,037 is a continuation-in-part of application No. 14/045,328, filed on Oct. 3, 2013, now abandoned.
Application No. 14/045,328 is a continuation-in-part of application No. 13/915,869, filed on Jun. 12, 2013, now abandoned.
Application No. 14/045,328 is a continuation-in-part of application No. 13/915,869, filed on Jun. 12, 2013, now abandoned.
Application No. 13/915,869 is a continuation-in-part of application No. 13/088,149, filed on Apr. 15, 2011, now Pat. No. 8,485,994.
(60) Provisional application No. 61/325,170, filed on Apr. 16, 2010.

(51) Int. Cl. A61H 1/02

(52) U.S. Cl. CPC A61H 1/0262; A61H 2201/149; A61H 2203/0456

(57) ABSTRACT

An automated system used for physical therapy, more particularly a motorized system of exercising a user's legs at variable cycles. The system utilizes a unique system of wheels connected to a motor and attached to a series of elongated components which facilitate the movement of a user's legs. The system of the present invention can provide users with increased mobility and enhanced circulation. The system may be useful for individuals recovering from an injury, individuals who are overweight, or individuals with diabetes. The system may also be used for exercises to provide leg extension and improve leg strength.

### CROSS-REFERENCES TO RELATED APPLICATIONS

This application is a continuation-in-part and claims benefit of U.S. patent application Ser. No. 16/734,809 filed Jan. 6, 2020, which is a continuation-in-part and claims benefit of U.S. patent application Ser. No. 15/217,037 filed Jul. 22, 2016, now U.S. Pat. No. 10,561,562, which is a continuation-in-part and claims benefit of U.S. patent application Ser. No. 14/045,328 filed Oct. 3, 2013, which is a continuation-in-part and claims benefit of U.S. patent application Ser. No. 13/915,869 filed Jun. 12, 2013, which is a continuation-in-part and claims benefit of U.S. patent application Ser. No. 13/088,149 filed Apr. 15, 2011, now U.S. Pat. No. 8,485,994, which is a non-provisional and claims benefit of U.S. Provisional Patent Application 61/325,170 filed Apr. 16, 2010, the specification(s) of which is/are incorporated herein in their entirety by reference.

U.S. patent application Ser. No. 15/217,037 filed Jul. 22, 2016 is also a continuation-in-part and claims benefit of U.S. patent application Ser. No. 13/915,869 filed Jun. 12, 2013, which is a continuation-in-part and claims benefit of U.S. patent application Ser. No. 13/088,149 filed Apr. 15, 2011, now U.S. Pat. No. 8,485,994, which is a non-provisional and claims benefit of U.S. Provisional Patent Application 61/325,170 filed Apr. 16, 2010, the specification(s) of which is/are incorporated herein in their entirety by reference.

### FIELD OF THE INVENTION

The present invention relates to automated devices used for physical therapy, more particularly to a motorized system of exercising a user's legs at variable cycles. More particularly, the system utilizes a series of wheels connected by a belt and attached to a series of elongated components which are connected to a motor to automatically facilitate the movement of a user's legs.

### BACKGROUND OF THE INVENTION

Many individuals who have suffered injuries require physical therapy to aid their recovery. Devices have been invented that simulate activities such as simple movements, walking, and the like. An automated physical therapy system providing a range of motion exercises for the legs of a user utilizing a motorized system may be capable of providing a user with leg movement to facilitate circulation and strengthening. A series of elongated components operatively connected to and moved by a motorized wheel may allow for the movement of the user's legs and may be adjusted to provide variable cycles to meet the individual rehabilitation needs of the user.

### BRIEF SUMMARY OF THE INVENTION

It is an objective of the present invention to provide a motorized physical therapy system that allows for automated physical therapy of a user's legs, as specified in the independent claims. Embodiments of the invention are given in the dependent claims. Embodiments of the present invention can be freely combined with each other if they are not mutually exclusive.

The present invention provides users with increased mobility and enhanced circulation in the legs of the user by actuating movement of the various joints and muscles of the legs. The system may be useful for individuals recovering from an injury, individuals who are overweight, or Individuals with diabetes. The system may also be used for exercises to provide leg extension and Improve leg strength.

The present invention may feature a motorized physical therapy system comprising a motorized wheel operatively attached by a belt to a plurality of other wheels. The plurality of wheels may rotate and move a plurality of elongated components, and some of these elongated components may support portions of a user's legs (calves, knees, etc). Moving these elongated components may move the user's legs in such a way that provides leg extension, aids leg circulation, and strengthens the muscles of the legs. In some embodiments, the motorized physical therapy system may exercise one leg of the user. In other embodiments, the motorized physical therapy system may exercise both legs of the user with similar movements. In still other embodiments, the motorized physical therapy system may exercise both legs of the user with different movements.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a diagram of an automated physical therapy system of the present invention.

FIG. 2A shows a diagram of the motion of the automated physical therapy system of FIG. 1. FIG. 2B shows a diagram of the motion of the lower leg exercise portion of the present invention. FIG. 2C shows a diagram of the knee exercise portion of the present invention.

FIG. 3 shows a diagram of an automated physical therapy system of the present invention with a second set of components for use in exercising a second leg of a user.

### DETAILED DESCRIPTION OF THE INVENTION

Following is a list of elements corresponding to a particular element referred to herein:
100 automated physical therapy system
111 second wheel
112 belt
113 third wheel
114 first motorized wheel
120 first elongated component
121 first proximal end
122 first distal end
130 second elongated component
131 second proximal end
132 second distal end
140 third elongated component
141 third proximal end
142 third distal end
150 rolling component
155 rolling wheel
160 fourth elongated component
161 fourth proximal end
162 fourth distal end
170 fifth elongated component
171 fifth proximal end
172 fifth distal end
180 joint
190 sixth elongated component
191 sixth proximal end
192 sixth distal end
200 fixed surface
220 duplicate first elongated component
230 duplicate second elongated component
240 duplicate third elongated component
250 duplicate rolling component
255 duplicate rolling wheel
260 duplicate fourth elongated component
270 duplicate fifth elongated component
280 duplicate joint
290 duplicate sixth elongated component
330 first extension component
370 second extension component
430 duplicate first extension component
470 duplicate second extension component

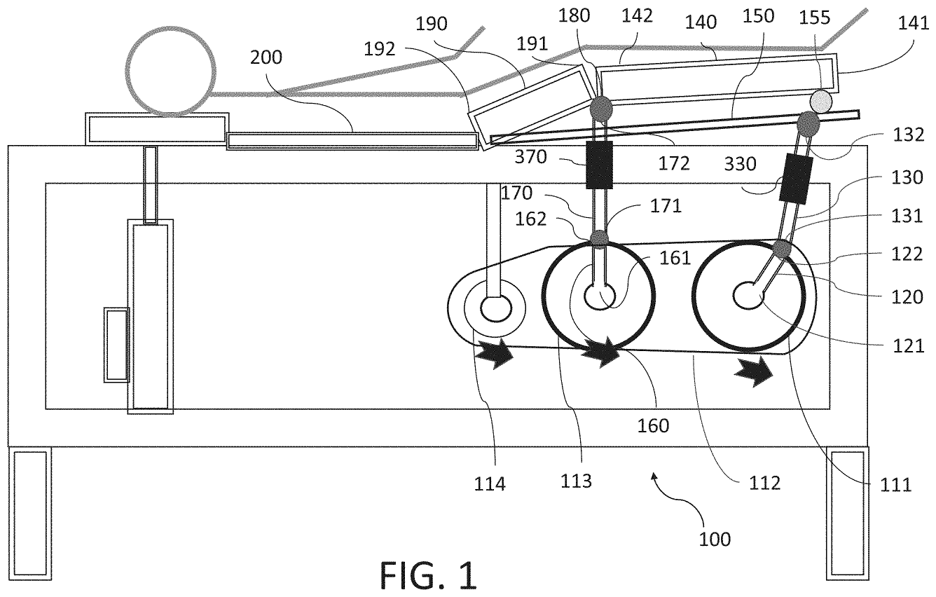

Referring now to FIG. 1, the present invention features an automated physical therapy system (100) providing range-of-motion exercises for a user. In some embodiments, the automated physical therapy system (100) may comprise a first motorized wheel (114) operatively connected to a second wheel (111) via a belt (112). The rotation of the first motorized wheel (114) may drive the rotation of the second wheel (111) via the belt (112). The first motorized wheel (114) may be further operatively connected to a third wheel (113) via the belt (112). The rotation of the first motorized wheel (114) may drive the rotation of the third wheel (113) via the belt (112). The system may further comprise a first elongated component (120) having a first proximal end (121) and a first distal end (122). The first proximal end (121) of the first elongated component (120) may fixedly attach to the second wheel (111), wherein the rotation of the second wheel (111) spins the first elongated component (120) about the second wheel (111). The system may further comprise a second elongated component (130) having a second proximal end (131) and a second distal end (132). In some embodiments, the second elongated component (130) may further comprise a first extension component (330). The second proximal end (131) of the second elongated component (130) may pivotably connect to the first distal end (122) of the first elongated component (120). The system may further comprise a third elongated component (140) having a third proximal end (141) and a third distal end (142). The third elongated component (140) may support a lower leg portion of a user. The third elongated component (140) may rest on a rolling wheel (155) and the rolling wheel (155) may rest on a rolling component (150) pivotably connected to a fixed surface (200). In some embodiments, the rolling wheel (155) may be rotatably attached to the third elongated component (140). The second elongated component (130) may connect to the rolling component (150) by the second distal end (132). Movement of the second elongated component (130) may cause vertical movement of the rolling component (150), actuating the rolling wheel (155) to roll and cause a lift-and-glide motion of the third elongated component (140).

In some embodiments, the system may further comprise a fourth elongated component (160) having a fourth proximal end (161) and a fourth distal end (162). The fourth proximal end (161) of the fourth elongated component (160) may fixedly attach to the third wheel (113), wherein the rotation of the third wheel (113) spins the fourth elongated component (160) about the third wheel (113). The system may further comprise a fifth elongated component (170) having a fifth proximal end (171) and a fifth distal end (172). In some embodiments, the fifth elongated component (170) may further comprise a second extension component (370). The fifth proximal end (171) of the fifth elongated component (170) may pivotably attach to a joint (180) between a sixth elongated component (190) having a sixth proximal end (191) and a sixth distal end (192) and the third elongated component (140). The sixth elongated component (190) may support an upper leg portion of a user and may connect to the third elongated component (140), creating the joint (180). Movement of the fifth elongated component (170) may cause vertical movement of the third elongated component (140) and the sixth elongated component (190) by pivoting the joint (180). The sixth distal end (192) of the sixth elongated component (190) may pivotably attach to the fixed surface (200). In some embodiments, the system (100) exercises a first leg of the user.

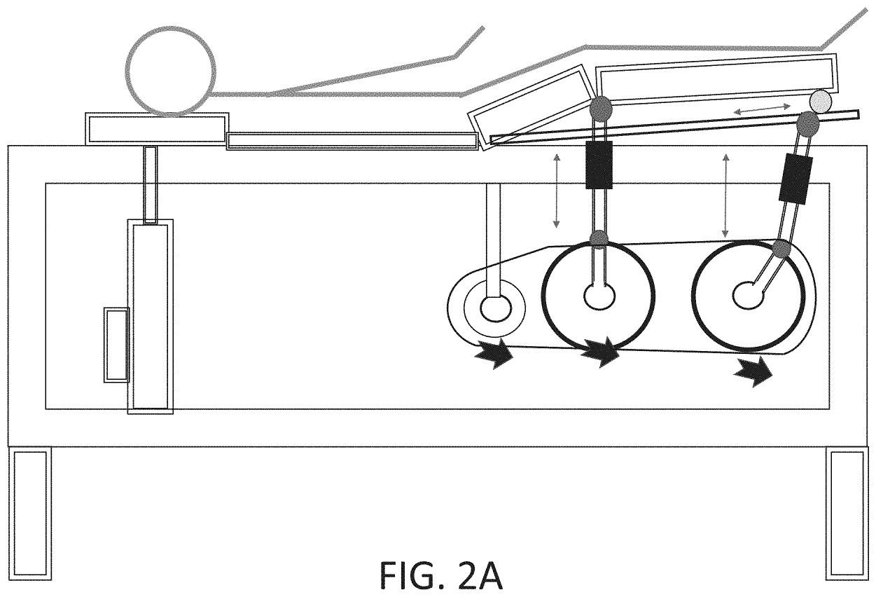

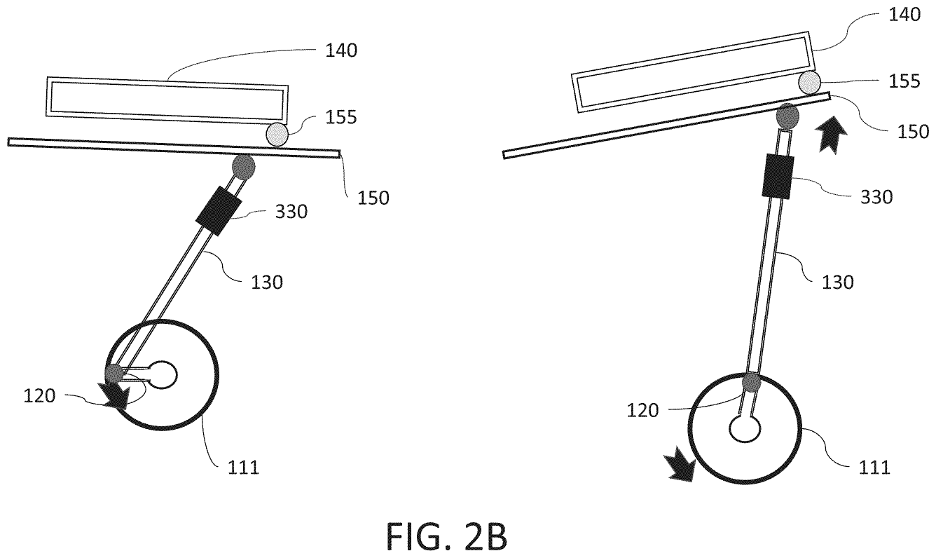

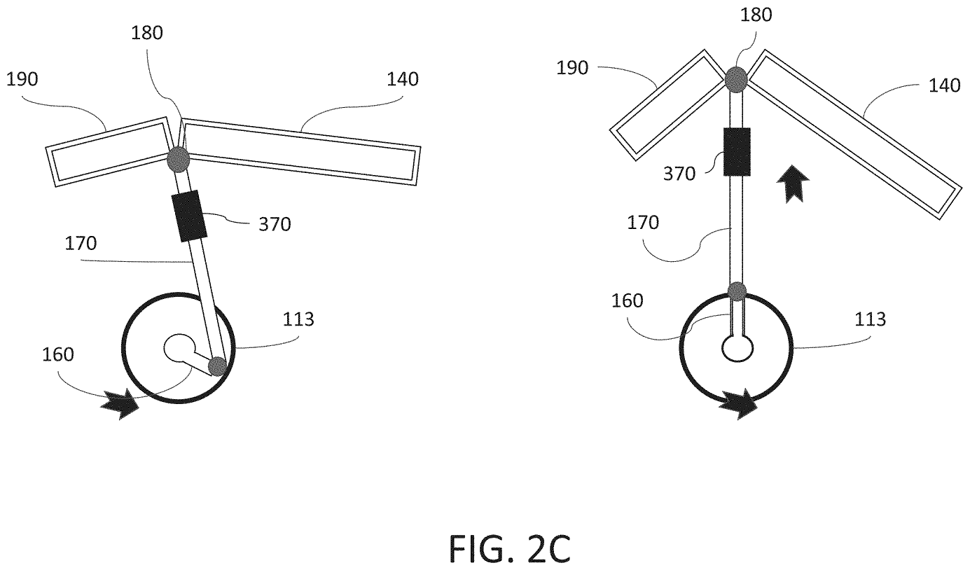

Referring now to FIG. 2A, the present invention features an automated physical therapy system (100) providing range-of-motion exercises for a user. A first elongated component (120) may spin about a second wheel (111), actuating movement in a second elongated component (130) attached to the first elongated component (120). Movement of the second elongated component (130) may actuate movement of a rolling component (150). A third elongated component (140) may rest on a rolling wheel (155) resting on the rolling component (150). In some embodiments, the rolling wheel (155) may be rotatably attached to the third elongated component (140). Movement of the rolling component (150) may cause the rolling wheel (155) to roll and cause a lift-and-glide motion of the third elongated component (140). In some embodiments, said movement is vertical and is applied to a lower leg portion of a user. Said movement is outlined in FIG. 28. A fourth elongated component (160) may spin about a third wheel (113), actuating movement in a fifth elongated component (170) attached to the fourth elongated component (160). Movement of the fifth elongated component (130) may actuate movement of a sixth elongated component (190) and the third elongated component (140), both attached to the fifth elongated component (170) at a joint (180). In some embodiments, said movement is vertical and is applied to a knee of a user. Said movement is outlined in FIG. 2C.

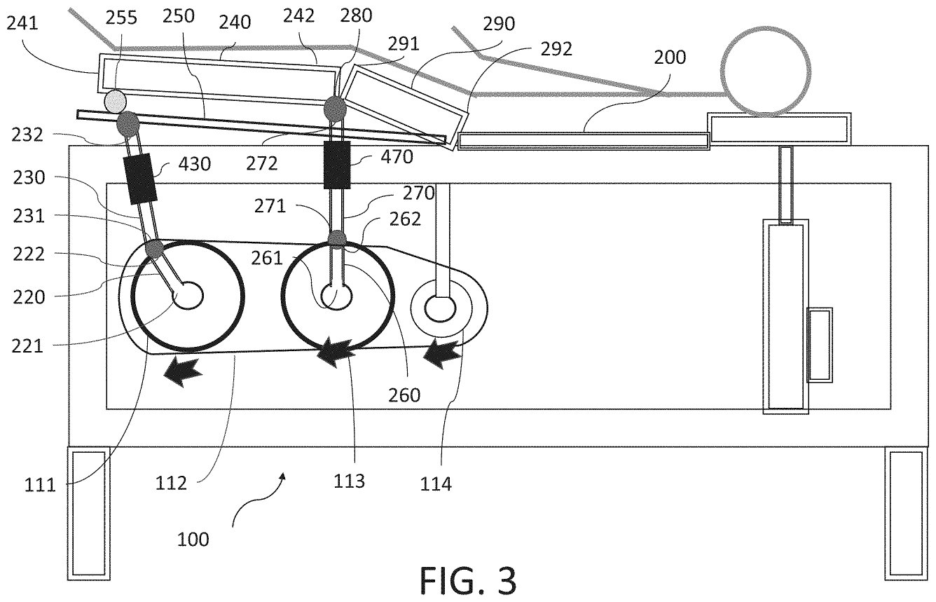

Referring now to FIG. 3, the automated physical therapy system (100) of the present invention may further comprise a second set of components. The second set of components may comprise a duplicate first elongated component (220), a duplicate second elongated component (230), a duplicate third elongated component (240), a duplicate fourth elongated component (260), a duplicate fifth elongated component (270), and a duplicate sixth elongated component (290). In some embodiments, the duplicate second elongated component (230) may further comprise a duplicate first extension component (430). In some embodiments, the duplicate fifth elongated component (270) may further comprise a duplicate second extension component (470). The duplicate first elongated component (220) may attach to the second wheel (111) and the duplicate second elongated component (230) may attach to the duplicate first elongated component (220) and attach to a duplicate rolling component (250). The duplicate third elongated component (240) may rest on a duplicate rolling wheel (255) resting on the duplicate rolling component (250). In some embodiments, the duplicate rolling wheel (255) may be rotatably attached to the duplicate third elongated component (240). The duplicate fourth elongated component (260) may attach to the third wheel (113) and the duplicate fifth elongated component (270) may attach to the duplicate third elongated component (240) and the duplicate sixth elongated component (290) at a duplicate joint (280). The duplicate third elongated component (240) may connect to the sixth elongated component (290) creating the duplicate joint (280). In some embodiments, the duplicate third elongated component (240) may support a lower leg portion of a user and the duplicate sixth elongated component (290) may support an upper leg portion of a user. Movement of the duplicate second elongated component (230) may cause vertical movement of the duplicate rolling component (250), causing the duplicate rolling wheel (255) to roll and cause a lift-and-glide motion of the duplicate third elongated component (240). Movement of the duplicate fifth elongated component (270) may cause vertical movement of the duplicate third elongated component (240) and the duplicate sixth elongated component (290) by pivoting the duplicate joint (280). As depicted in FIG. 3, the system (100) may exercise both a first leg and a second leg. In some embodiments, the system (100) may move the first leg in an identical motion to the second leg. In other embodiments, the system (100) may move the first leg in a different motion to the second leg.

In some embodiments, the motorized physical therapy system of the present invention is contained in a shell, such that the shell exposes components that are meant to interact with a user and conceals components that do not directly interact with the user. The motorized physical therapy system of the present invention may be 8 feet in length, 4 feet in width, and 4 feet in height. An elongated component may be 6 Inches to 24 inches in length. In some embodiments, the motorized physical therapy system of the present invention may be large enough to support a fully-grown adult. In some embodiments, components of the motorized physical therapy system may be adjustable to fit a plurality of body types and sizes.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. An automated physical therapy system (100) providing range of motion exercises for a user, wherein the automated physical therapy system (100) comprises:
a. a first motorized wheel (114) operatively connected to a second wheel (111) via a belt (112), wherein the rotation of the motorized wheel (114) drives the rotation of the second wheel (111) via the belt (112),
wherein the first motorized wheel (114) is further operatively connected to at least a third wheel (113) via the belt (112) wherein the rotation of the first motorized wheel (114) drives the rotation of the third wheel (113) via the belt (112);
b. a first elongated component (120) having a first proximal end (121) and a first distal end (122), wherein the first proximal end (121) of the first elongated component (120) fixedly attaches to the second wheel (111), wherein the rotation of the second wheel (111) rotates the first elongated component (120) about an axis of the second wheel (111);
c. a second elongated component (130) having a second proximal end (131) and a second distal end (132), wherein the second proximal end (131) of the second elongated component (130) pivotably connects to the second distal end (122) of the first elongated component (120);
d. a third elongated component (140) having a third proximal end (141) and a third distal end (142),
wherein the third elongated component (140) rests on a wheel (155),
wherein the wheel (155) rests on a rolling component (150) pivotably attached to a fixed surface (200), and
wherein the second elongated component (130) pivotably attaches to the rolling component (150) at the third distal end (132);
e. a fourth elongated component (160) having a fourth proximal end (161) and a fourth distal end (162),
wherein the fourth proximal end (161) of the fourth elongated component (160) fixedly attaches to the third wheel (113),
wherein the rotation of the third wheel (113) rotates the fourth elongated component (160) about an axis of the third wheel (113);
f. a fifth elongated component (170) having a fifth proximal end (171) and a fifth distal end (172),
wherein the fifth distal end (171) is operatively attached to a joint (180) between a sixth elongated component (190), having a sixth proximal end (191) and a sixth distal end (192), and the third elongated component (140),
wherein the sixth distal end (192) of the sixth elongated component (190) is pivotably attached to a fixed surface (200), and
wherein the sixth proximal end (191) is pivotably attached to the third distal end (142) to create the joint (180).

2. The system (100) of claim 1, wherein the system (100) exercises a first leg of a user such that the third elongated component (140) exercises a lower portion of the first leg, the sixth elongated component (190) supports an upper portion of the first leg, and the joint (180) exercises a knee of the first leg.

3. The system (100) of claim 1, wherein moving the second elongated component (130) causes vertical movement of the rolling component (150), causing the wheel (155) to roll along the rolling component (150) and actuate a lift-and-glide motion in the third elongated component (140).

4. The system (100) of claim 1, wherein moving the fifth elongated component (170) causes vertical movement of the third elongated component (140) and the sixth elongated component (190) by pivoting the joint (180).

5. The system (100) of claim 1, further comprising:
a. a duplicate first elongated component (220), a duplicate second elongated component (230), a duplicate third elongated component (240), a duplicate fourth elongated component (260), a duplicate fifth elongated component (270), and a duplicate sixth elongated component (290);
wherein the duplicate first elongated component (220) attaches to the second wheel (111);
wherein the duplicate third elongated component (240) rests on a duplicate wheel (255),
wherein the duplicate wheel (255) rests on a duplicate rolling component (250) pivotably attached to a fixed surface (200), and
wherein the duplicate second elongated component (230) pivotably attaches to the duplicate rolling component (250) at the distal end (232);
wherein the duplicate fourth elongated component (260) attaches to the third wheel (113);
wherein the duplicate fifth elongated component (270) attaches to the duplicate third elongated component (240) and the duplicate sixth elongated component (290) at a joint (280); and
wherein the duplicate third elongated component (240) pivotably attaches to the duplicate sixth elongated component (290) to create the joint (280).

6. The system (100) of claim 5, wherein the system (100) exercises a second leg of the user such that the duplicate third elongated component (240) exercises a lower portion of the first leg, the duplicate sixth elongated component (290) supports an upper portion of the first leg, and the duplicate joint (280) exercises a knee of the first leg.

7. The system (100) of claim 1, wherein moving the duplicate second elongated component (230) causes vertical movement of the duplicate rolling component (250), causing the duplicate wheel (255) to roll along the duplicate rolling component (250) and actuate a lift-and-glide motion in the duplicate third elongated component (240).

8. The system (100) of claim 5, wherein moving the duplicate fifth elongated component (270) causes vertical movement of the duplicate third elongated component (240) and the duplicate sixth elongated component (290) by pivoting the duplicate joint (280).
